(19) United States
(12) Patent Application Publication
(10) Pub. No.: US 2014/0247883 A1
(43) Pub. Date: Sep. 4, 2014

(54) SCALABLE VIDEO ENCODING AND DECODING METHOD AND APPARATUS USING SAME

(71) Applicant: Electronics and Telecommunications Research Institute, Daejeon (KR)

(72) Inventors: Ha Hyun Lee, Seoul (KR); Jung Won Kang, Daejeon (KR); Jin Soo Choi, Daejeon (KR); Jin Woong KIim, Daejeon (KR)

(21) Appl. No.: 14/350,230

(22) PCT Filed: Oct. 5, 2012
(86) PCT No.: PCT/KR2012/008100

§ 371 Date: Apr. 7, 2014

(30) Foreign Application Priority Data
Oct. 5, 2011 (KR) 10-2011-0101140
Sep. 10, 2012 (KR) 10-2012-0099967
Oct. 5, 2012 (KR) 10-2012-0110780

(51) Int. Cl. H04N 19/30; H04N 19/51; H04N 19/593

(52) U.S. Cl. CPC H04N 19/00424; H04N 19/00763; H04N 19/00684
USPC 375/240.16; 375/240.12

(57) ABSTRACT

An interlayer prediction method according to the present invention comprises: a step of determining the position of a reference criteria sample corresponding to an enhancement criteria sample in a reference layer on the basis of the position of an enhancement criteria sample that belongs to an enhancement layer; a step of determining at least one reference layer block in the reference layer on the basis of the position of the reference criteria sample; and a step of predicting the current block that belongs to the enhancement layer on the basis of the movement information of said at least one reference layer block.

### CROSS-REFERENCE TO RELATED APPLICATIONS

This application claims the benefit of priority of Korean Patent Application No. 10-2011-0101140 filed on Oct. 5, 2011, Korean Patent Application No. 10-2012-0099967 filed on Sep. 10, 2012, and Korean Patent Application No. 10-2012-0110780 filed on Oct. 5, 2012, all of which is incorporated by reference in its entirety herein.

### BACKGROUND OF THE INVENTION

1. Field of the Invention

The present invention relates to an image processing, and more particularly, to a method of encoding and decoding scalable video based on scalable video coding (hereinafter, referred to as ‘SVC’) and an apparatus using the same.

2. Related Art

Nowadays, as a multimedia environment is constructed, various terminals and networks are used and thus a user request variously changes.

For example, as a performance and a computing ability of a terminal variously changes, a support performance thereof variously changes on a device basis. Further, a network in which information is transmitted variously changes according to a function such as a form, an information amount, and a speed of transmitting information as well as an external structure such as wired and wireless networks. A user selects a terminal and a network to use according to a desired function, and a spectrum of a terminal and a network in which a corporation provides to the user variously changes.

In relation thereto, nowadays, while a broadcasting service having a high definition (HD) resolution is enlarged to world as well as domestic, many users are familiar in an image of a high resolution and a high quality. Therefore, many image service related institutions make an effort for development of a next generation image device.

Further, while an interest about ultra high definition (UHD) having a resolution of quadruple or more of HDTV together with HDTV increases, a request for technology that compresses and processes an image of a higher resolution and a high quality increases.

In order to compress and process an image, inter prediction technology that predicts a pixel value included from a prior picture and/or a posterior picture to a current picture, intra prediction technology that predicts other pixel values included in a current picture using pixel information within the current picture, and entropy encoding technology that allocates a short code to a symbol having a high appearance frequency and that allocates a long code to a symbol having a low appearance frequency is used.

As described above, in consideration of each terminal, a network, and a diversified user request having different support functions, it is necessary to diversify a quality, a size, and a frame of a support image.

In this way, due to different kinds of communication networks and various functions/kinds of terminals, scalability that variously supports a quality, a resolution, a size, and a frame rate of an image becomes an important function of a video format.

Therefore, in order to provide a service in which a user requests in various environments based on a video encoding method of high efficiency, it is necessary to provide a scalability function for effectively encoding and decoding video from time, space, and quality viewpoints.

### SUMMARY OF THE INVENTION

The present invention has been made in an effort to provide a method and apparatus for encoding scalable video that can improve encoding/decoding efficiency.

The present invention has been made in an effort to further provide a method and apparatus for decoding scalable video that can improve encoding/decoding efficiency.

The present invention has been made in an effort to further provide a method and apparatus for inter layer prediction that can improve encoding/decoding efficiency.

An exemplary embodiment of the present invention provides a method of performing an inter layer prediction. The method includes determining a position of a reference sample corresponding to an enhancement reference sample within a reference layer based on a position of the enhancement reference sample that belongs to an enhancement layer, determining at least one reference layer block in the reference layer based on the position of the reference sample, and performing a prediction of a current block that belongs to the enhancement layer based on motion information of the at least one reference layer block. In this case, the position of the enhancement reference sample is determined as a relative position of the current block, and the position of the reference sample corresponding to the enhancement reference sample is determined based on an input picture size ratio between an input picture of the enhancement layer and an input picture of the reference layer.

The enhancement reference sample may include at least one of a left upper end sample positioned at a leftmost upper end portion of the inside of the current block, a left upper end center sample positioned at a left upper end portion among four samples positioned at the center of the inside of the current block, a right lower end corner sample positioned most adjacent to a right lower end corner of the outside of the current block, a left lower end corner sample positioned most adjacent to a left lower end corner of the outside of the current block, and a right upper end corner sample positioned most adjacent to a right upper end corner of the outside of the current block.

At the determining of at least one reference layer block, at least one of a first block including the position of the reference sample and a second block positioned at a periphery of the first block may be determined as the reference layer block, and the second block may include at least one of blocks positioned adjacent to the first block and blocks positioned most adjacent to a corner of the outside of the first block.

At the determining of at least one reference layer block, when a first block including the position of the reference sample is unavailable or when a prediction mode of the first block is an intra mode, a second block positioned at a periphery of the first block may be determined as the reference layer block, and the second block may include at least one of blocks positioned adjacent to the first block and blocks positioned most adjacent to a corner of the outside of the first block.

At the determining of at least one reference layer block, when a first block including the position of the reference sample is unavailable or when a prediction mode of the first block is an intra mode, a second block including a position of another sample, not the reference sample within the reference layer may be determined as the reference layer block, and the position of another sample, not the reference sample may be determined based on a sample of a position different from the enhancement reference sample corresponding to the reference sample among samples within the enhancement layer.

The performing of the prediction may include receiving image information including a motion vector predictor (MVP) index and a motion vector difference (MVD), generating an MVP candidate list including a plurality of MVP candidates based on motion information of the at least one reference layer block, determining an MVP of the current block based on the MVP index and the MVP candidate list, deriving a motion vector of the current block by adding the determined MVP and the MVD, and performing a prediction of the current block based on the derived motion vector. In this case, the MVP index may indicate an MVP candidate to be used as an MVP of the current block among a plurality of MVP candidates constructing the MVP candidate list, and the MVD may be a difference value between the motion vector of the current block and the MVP of the current block.

At the generating of the MVP candidate list, an MVP candidate corresponding to each of motion information of the at least one reference layer block may be derived based on the input picture size ratio.

The MVP candidate list may include at least one of a first MVP candidate derived based on a reconstructed neighboring block, a second MVP candidate derived based on a co-located block, and a third MVP candidate derived based on the at least one reference layer block, the reconstructed neighboring block may include at least one of blocks positioned adjacent to the current block and blocks positioned most adjacent to a corner of the outside of the current block, and the co-located block may be one of a plurality of blocks constructing a reference picture, not a current picture to which the current block belongs.

The first MVP candidate may be derived based on a motion vector of a block existing at the same spatial position as that of the reconstructed neighboring block within the reference layer, when the reconstructed neighboring block is unavailable or when a prediction mode of the reconstructed neighboring block is an intra mode.

AN MVP index value smaller than that of the first MVP candidate and the second MVP candidate may be allocated to the third MVP candidate.

The third MVP candidate may be derived by scaling motion information of at least one reference layer block based on a first temporal distance from the current block to a first reference picture in which the current block refers when performing an inter prediction and a second temporal distance from at least one reference layer block to a second reference picture in which the at least one reference layer block refers when performing an inter prediction. In this case, the first reference picture may be a block belonging to the enhancement layer, and the second reference picture may be a block belonging to the reference layer.

The performing of the prediction may further include receiving image information including a merge index, generating a merge candidate list including a plurality of merge candidates based on motion information of the at least one reference layer block, determining motion information of the current block based on the merge index and the merge candidate list, and performing a prediction of the current block based on the determined motion information. In this case, the merge index may indicate a merge candidate to be used as motion information of the current block among a plurality of merge candidates constructing the merge candidate list.

At the generating of the merge candidate list, a merge candidate corresponding to each of motion information of the at least one reference layer block may be derived based on the input picture size ratio.

The merge candidate list may include at least one of a first merge candidate derived based on a reconstructed neighboring block, a second merge candidate derived based on co-located block, and a third merge candidate derived based on the at least one reference layer block. In this case, the reconstructed neighboring block may include at least one of blocks positioned adjacent to the current block and blocks positioned most adjacent to a corner of the outside of the current block, and the co-located block may be one of a plurality of blocks constructing a reference picture, not a current picture to which the current block belongs.

The first merge candidate may be derived based on a motion vector of a block existing at the same spatial position as that of the reconstructed neighboring block within the reference layer, when the reconstructed neighboring block is unavailable or when a prediction mode of the reconstructed neighboring block is intra mode.

A merge index value smaller than that of the first merge candidate and the second merge candidate may be allocated to the third merge candidate.

The generating of the merge candidate list may include determining a reference picture index corresponding to the third merge candidate. Here, the reference picture index may indicate a first reference picture in which the current block refers when performing an inter prediction, when the third merge candidate is determined as motion information of the current block, the first reference picture may be a picture having the same picture order count (POC) value as a POC value of a second reference picture in which the at least one reference layer block refers when performing an inter prediction. Further, the first reference picture may be a picture belonging to the enhancement layer, and the second reference picture may be a picture belonging to the reference layer.

Another embodiment of the present invention provides a method of decoding scalable video. The method includes determining a position of a reference sample corresponding to an enhancement reference sample within a reference layer based on a position of the enhancement reference sample belonging to an enhancement layer, determining at least one reference layer block in the reference layer based on the position of the reference sample, generating a prediction block corresponding to a current block by performing a prediction of the current block belonging to the enhancement layer based on motion information of the at least one reference layer block, and generating a reconstruction block corresponding to the current block based on the prediction block. In this case, the position of the enhancement reference sample may be determined as a relative position to the current block, and the position of the reference sample corresponding to the enhancement reference sample may be determined based on an input picture size ratio between an input picture of the enhancement layer and an input picture of the reference layer.

In a method of encoding scalable video according to the present invention, encoding/decoding efficiency can be improved.

In a method of decoding scalable video according to the present invention, encoding/decoding efficiency can be improved.

In a method of inter layer prediction according to the present invention, encoding/decoding efficiency can be improved.

### BRIEF DESCRIPTION OF THE DRAWINGS

FIG. 1 is a block diagram illustrating a basic configuration according to an exemplary embodiment of an image encoding apparatus.

FIG. 2 is a block diagram illustrating a basic configuration according to an exemplary embodiment of an image decoding apparatus.

FIG. 3 is a diagram illustrating a scalable video coding structure using multiple layers according to an exemplary embodiment of the present invention.

FIG. 4 is a flowchart illustrating an inter prediction method to be applied to scalable video coding according to an exemplary embodiment of the present invention.

FIG. 5 is a diagram illustrating a method of deriving a position of a reference sample based on a position of an enhancement reference sample.

FIG. 6 is a flowchart illustrating a method of determining a reference layer block according to an exemplary embodiment of the present invention.

FIG. 7 is a diagram illustrating an exemplary embodiment of a method of deriving a motion information candidate in an AMVP mode and a merge mode.

### DESCRIPTION OF EXEMPLARY EMBODIMENTS

Hereinafter, an exemplary embodiment according to the present invention will be described in detail with reference to the drawings. Further, detailed descriptions of well-known functions and structures incorporated herein may be omitted to avoid obscuring the subject matter of the present invention.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

A term such as a first and a second may be used for describing various configurations, but the configurations are not limited by the term. The terms are used for distinguishing one configuration from another configuration. For example, a first configuration may be referred to as a second configuration and a second configuration may be referred to as a first configuration without departing from the spirit or scope of the present invention

Further, constituent elements described in an exemplary embodiment of the present invention are independently described to represent different characteristic functions, and it does not mean that each constituent element are formed with separated hardware or one software constituent unit. That is, for convenience of description, each constituent element is individually arranged and included, and at least two of constituent elements may form one constituent element or one constituent element may be divided into a plurality of constituent elements and perform a function. An integrated exemplary embodiment and a separated exemplary embodiment of each constituent element are included in the scope of the present invention when departing from the spirit of the present invention.

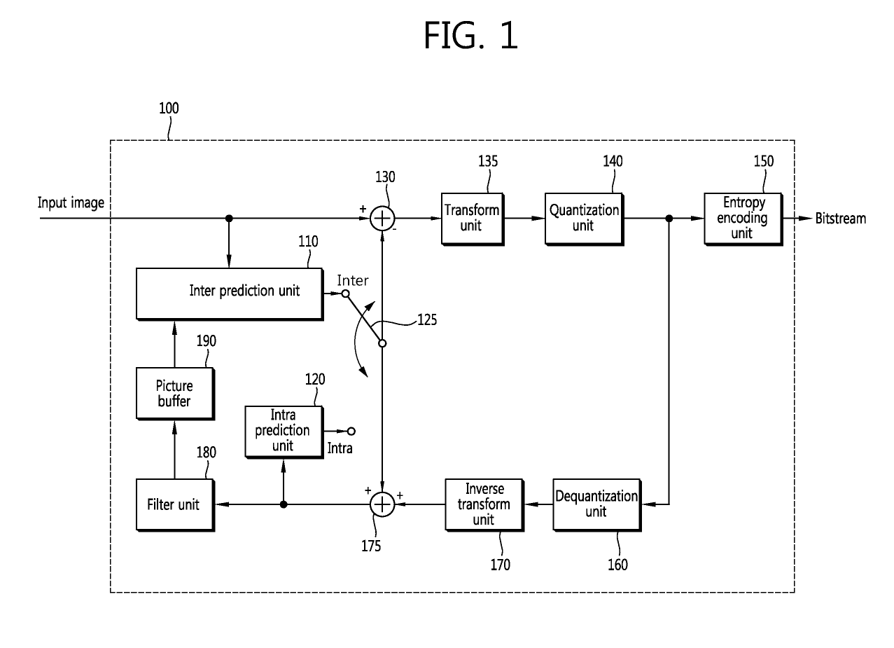

FIG. 1 is a block diagram illustrating a basic configuration according to an exemplary embodiment of an image encoding apparatus. A method or an apparatus for encoding/decoding scalable video can be embodied by extension of a method or an apparatus for encoding/decoding a general image that does not provide scalability, and a block diagram of FIG. 1 illustrates an exemplary embodiment of an image encoding apparatus that may become a base of a scalable video encoding apparatus.

Referring to FIG. 1, an image encoding apparatus 100 includes an inter prediction unit 110, an intra prediction unit 120, a switch 125, a subtractor 130, a transform unit 135, a quantization unit 140, an entropy encoding unit 150, a dequantization unit 160, an inverse transform unit 170, an adder 175, a filter unit 180, and a picture buffer 190.

The image encoding apparatus 100 may encode an input image in an intra mode or an inter mode and output bitstream. In the intra mode, the switch 125 is transformed to intra, and in the inter mode, the switch 125 is transformed to inter. The image encoding apparatus 100 may generate a prediction block of an input block of an input image and encode a difference of the input block and the prediction block.

In the intra mode, the intra prediction unit 120 may perform a spatial prediction using a pixel value of an already encoded block at a peripheral of a current block and generates a prediction block. In the inter mode, in a motion prediction process, the inter prediction unit 110 may find an area corresponding to an input block in a reference image stored at the picture buffer 190 and obtains a motion vector. The inter prediction unit 110 may perform motion compensation using the motion vector and the reference image stored at the picture buffer 190, thereby generating a prediction block. In this case, a processing unit in which a prediction is performed and a processing unit in which a prediction method and detailed contents are determined may be different. For example, when a prediction mode is determined in a PU unit, a prediction may be performed in a TU unit, and when a prediction mode is determined in a PU unit, a prediction may be performed in a TU unit.

The subtractor 130 may generate a residual block by a difference between an input block and a generated prediction block. The transform unit 135 may transform the residual block and outputs a transform coefficient. The quantization unit 140 may quantize the input transform coefficient according to a quantization parameter and output the quantized coefficient.

The entropy encoding unit 150 may entropy-encode the quantized coefficient according to probability distribution based on values obtained in the quantization unit 140 or an encoding parameter value obtained in an encoding process, thereby outputting bitstream.

The quantized coefficient is dequantized in the dequantization unit 160 and is inversely transformed in the inverse transform unit 170. The dequantized and inversely transformed coefficient is added to the prediction block through the adder 175, and a reconstruction block is generated.

The reconstruction block passes through the filter unit 180, and the filter unit 180 applies at least one of a deblocking filter, sample adaptive offset (SAO), and an adaptive loop filter (ALF) to the reconstruction block or a reconstruction picture. The reconstruction block, having passed through the filter unit 180 is stored at the picture buffer 190.

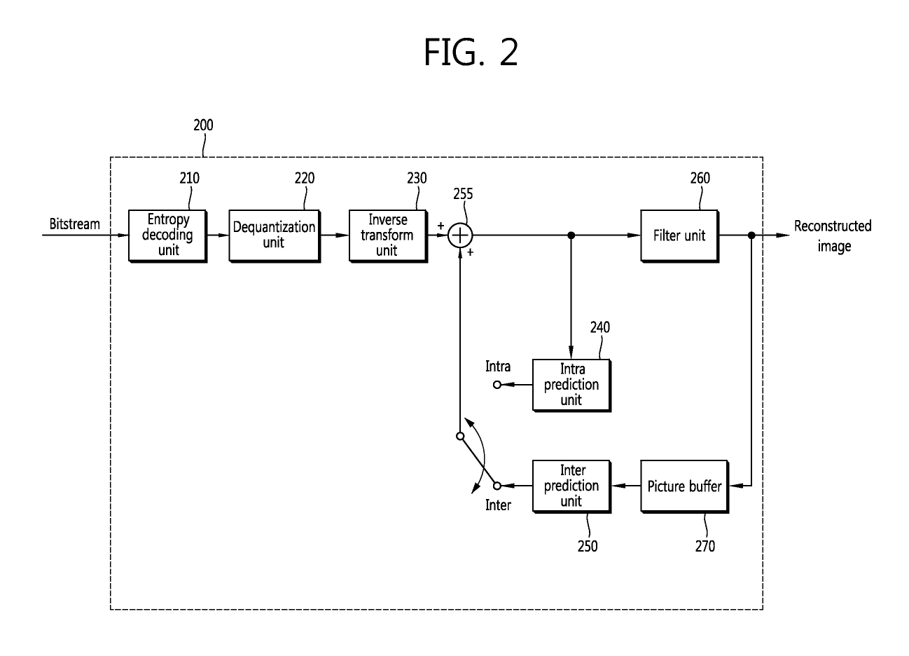

FIG. 2 is a block diagram illustrating a basic configuration according to an exemplary embodiment of an image decoding apparatus. As described in relation to FIG. 1, a method or an apparatus for encoding/decoding scalable video can be embodied by extension of a method or an apparatus for encoding/decoding a general image that does not provide scalability, and a block diagram of FIG. 2 illustrates an exemplary embodiment of an image decoding apparatus that may become a base of a scalable video decoding apparatus.

Referring to FIG. 2, an image decoding apparatus 200 includes an entropy decoding unit 210, a dequantization unit 220, an inverse transform unit 230, an intra prediction unit 240, an inter prediction unit 250, a filter unit 260, and a picture buffer 270.

The image decoding apparatus 200 may receive bitstream output from an encoding apparatus, decode the bitstream in an inter mode or an intra mode, and output a reconfigured image, i.e., a reconstruction image. In the intra mode, the switch may be switched to intra, and in the inter mode, the switch may be switched to inter.

The image decoding apparatus 200 may obtain a residual block reconstructed from the input bitstream, generate a prediction block, and generate a reconfigured block, i.e., a reconstruction block by adding the reconstructed residual block and the prediction block.

The entropy decoding unit 210 may entropy-decode the input bitstream according to probability distribution. By entropy-decoding, a quantized (transform) coefficient is generated.

The quantized coefficient is dequantized in the dequantization unit 220 and is inversely transformed in the inverse transform unit 230, and as the quantized coefficient is dequantized/inversely transformed, a reconstructed residual block is generated.

In the intra mode, the intra prediction unit 240 may perform a spatial prediction using a pixel value of an already encoded block at a periphery of a current block, thereby generating a prediction block. In the inter mode, the inter prediction unit 250 may perform motion compensation using a motion vector and a reference image stored at the picture buffer 270, thereby generating a prediction block. In this case, a processing unit in which a prediction is performed and a processing unit in which a prediction method and detailed contents are determined may be different. For example, when a prediction mode is determined in a PU unit, a prediction may be performed in a TU unit, and when a prediction mode is determined in a PU unit, a prediction may be performed in a TU unit.

The reconstructed residual block and the prediction block are added through an adder 255, and the added block passes through the filter unit 260. The filter unit 260 may apply at least one of a deblocking filter, SAO, and ALF to the reconstruction block or a reconstruction picture. The filter unit 260 may output a reconfigured image, i.e., a reconstructed image. The reconstructed image is stored at the picture buffer 270 and is used for an inter prediction.

Hereinafter, a block is a unit for encoding and decoding an image. When encoding and decoding an image, an encoding or decoding unit is a divided unit when dividing an image into a subdivided unit and encoding or decoding the divided image, and the encoding or decoding unit is referred to as a macro block, a coding unit (CU), a prediction unit (PU), a transform unit (TU), and a transform block. Therefore, in this specification, a block (and/or an encoding/decoding target block) indicates a coding unit, a prediction unit and/or a transform unit corresponding to the block (and/or an encoding/decoding target block). Such classification may easily performed by a person of ordinary skill in the art.

With the development of communication and image technology, various devices using image information have different performances and are used. Devices such as a mobile phone reproduce a moving picture of a relatively lower resolution based on bitstream. However, devices such as a personal computer (PC) reproduce a moving picture of a relatively high resolution.

Therefore, a method of providing an optimal moving picture service to devices of various performances is necessary. One of solutions thereof is scalable video coding (hereinafter, referred to as ‘SVC’).

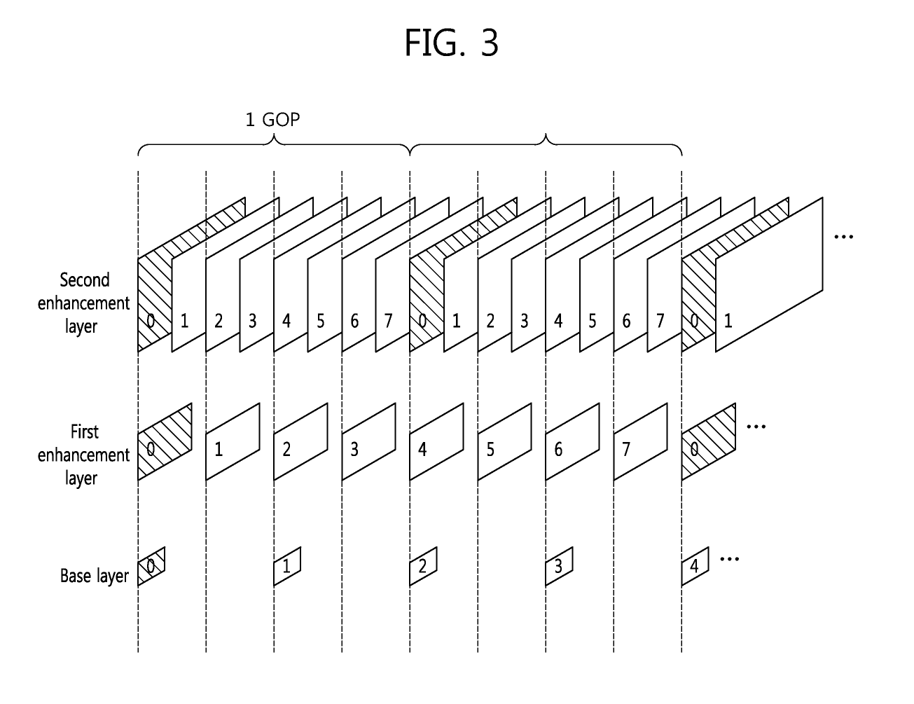

FIG. 3 is a diagram illustrating a scalable video coding structure using multiple layers according to an exemplary embodiment of the present invention. In FIG. 3, a group of picture (GOP) represents a group of pictures.

In order to transmit image data, a transmission medium is necessary, and performances thereof are different on a transmission medium basis according to various network environments. For application to such various transmission medium or network environments, a scalable video coding method may be provided.

A SVC method is a coding method of increasing an encoding/decoding performance by removing overlapping between layers using texture information, motion information, and a residual signal between layers. For example, in a scalable video encoding/decoding process, in order to improve encoding/decoding efficiency by removing overlapping between layers, an inter layer texture prediction, an inter layer motion information prediction and/or an inter layer residual signal prediction are applied. The SVC provides various scalability from spatial, temporal, and quality viewpoints according to a peripheral condition such as a transmission bit rate, a transmission error rate, and a system resource.

In order to provide bitstream that can apply to various network situations, SVC uses a multiple layer structure. For example, the SVC includes a base layer that processes image information using a general image encoding method and an enhancement layer that processes image information using together encoding information of the base layer and a general image encoding method.

A layer structure includes a plurality of spatial layers, a plurality of temporal layers, and a plurality of quality layers. Images included in different spatial layers may have different spatial resolutions, and images included in different temporal layers have different temporal resolutions (frame rate). Further, images included in different quality layers may have different qualities, for example, different signal-to-noise ratios (SNR).

Here, a layer is a set of an image and/or bitstream divided based on space (e.g., an image size), a time (e.g., an encoding order, an image output order), a quality, and complexity. Further, multiple layers may have dependency.

Referring to FIG. 3, as described above, an SVC structure includes multiple layers. FIG. 3 illustrates an example in which pictures of each layer are arranged according to a POC (Picture Order Count). Each layer, i.e., a base layer and enhancement layers may have a characteristic of different bit rates, resolutions, and sizes. Bitstream of the base layer includes basic image information, and bitstream of the enhancement layer includes information of an image in which a quality (accurateness, size and/or frame rate) of the base layer is further improved.

Therefore, each layer may be encoded/decoded in consideration of different characteristics. For example, the encoding apparatus of FIG. 1 and the decoding apparatus of FIG. 2 may encode and decode a picture of a corresponding layer on a layer basis, as described in relation to FIGS. 1 and 2.

Further, a picture of each layer may be encoded/decoded using information of another layer. For example, a picture of each layer may be encoded/decoded through an inter layer prediction using information of another layer. Therefore, in the SVC structure, a prediction unit of the encoding apparatus and the decoding apparatus described in relation to FIGS. 1 and 2 may perform a prediction using information of another layer, i.e., a reference layer. The prediction unit of the encoding apparatus and the decoding apparatus may perform an inter layer texture prediction, an inter layer motion information prediction, and an inter layer residual signal prediction using information of another layer.

The inter layer texture prediction may predict texture of a current layer (encoding or decoding target layer) based on texture information of another layer. The inter layer motion information prediction may predict motion information of a current layer based on motion information (motion vector, reference picture) of another layer. The inter layer residual signal prediction may predict a residual signal of a current layer based on a residual signal of another layer.

In the SVC, a current layer is encoded and decoded using information of another layer and thus complexity that processes overlapped information between layers may be reduced, and an overhead that transmits overlapped information may be reduced.

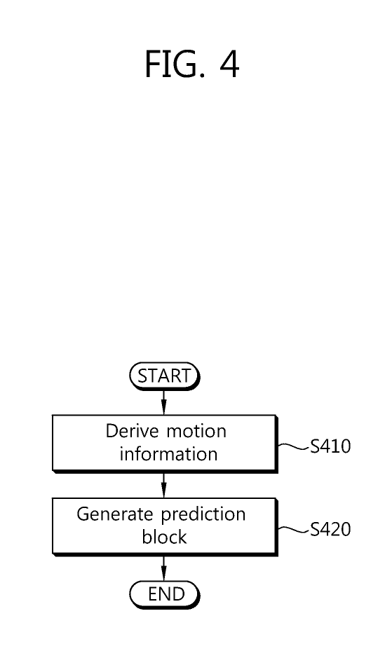

FIG. 4 is a flowchart illustrating an inter prediction method to be applied to scalable video coding according to an exemplary embodiment of the present invention.

In an exemplary embodiment of FIG. 4, unless stated otherwise, the same method may be applied to a scalable video encoder (hereinafter, referred to as an encoder) and a scalable video decoder (hereinafter, referred to as a decoder). That is, the decoder may perform an inter prediction with the same method as that in the encoder.

When performing an inter prediction, the encoder and the decoder may determine at least one of prior pictures and posterior pictures of a current picture to which an encoding/decoding target block belongs as a reference picture. Here, the reference picture is a picture used for predicting an encoding/decoding target block and is referred to as a reference frame. A picture used as a reference picture among prior pictures and posterior pictures of a current picture is indicated using a reference picture index.

In this case, the encoder and the decoder may predict an encoding/decoding target block based on the determined reference picture. The encoder and the decoder may select a reference block corresponding to the encoding/decoding target block within the reference picture and generate a prediction block corresponding to the encoding/decoding target block based on the selected reference block. A position of the reference block that belongs to the reference block is represented through a motion vector.

The encoder may perform a prediction so that a residual signal and a size of a motion vector corresponding to the encoding/decoding target block becomes the minimum based on rate-distortion optimization. In this case, in the prediction process, the encoder may generate information related to a reference picture index and a motion vector, encode the generated information, and transmit the generated information to the decoder. In this case, the decoder may perform an inter prediction based on the transmitted information. Hereinafter, in this specification, motion information may include a reference picture index and a motion vector.

In an exemplary embodiment of FIG. 4, an inter layer prediction (e.g., an inter layer motion information prediction) may be applied. That is, an inter prediction method according to an exemplary embodiment of FIG. 4 may correspond to an inter layer prediction method (e.g., an inter layer motion prediction method). Here, an inter layer prediction may be a method of determining or predicting a data value of an enhancement layer. In this time, a layer to be a base of a prediction may be referred to as a reference layer.

When an inter layer prediction is performed, the encoder and the decoder may predict information of an enhancement layer using information of a lower layer such as a base layer. Therefore, an amount of information transmitted or processed for predicting the enhancement layer may be greatly reduced. In this case, in order to reconstruct information of a upper layer, for example, the enhancement layer, the encoder and the decoder may use information of a reconstructed lower layer. As an example, when an input image size of the enhancement layer is larger than that of a lower layer, the encoder and the decoder may up-sample and use information of the reconstructed subordinate layer. In an exemplary embodiment of FIG. 4, it is assumed that an encoding/decoding target block (e.g., PU) is a block belonging to the enhancement layer.

Referring to FIG. 4, the encoder and the decoder may derive motion information of the encoding/decoding target block (S410).

In an inter mode, the encoder and the decoder may derive motion information of the encoding/decoding target block and perform an inter prediction and/or motion compensation based on the derived motion information. In this case, the encoder and the decoder may use motion information of a ‘reference layer block’ corresponding to the encoding/decoding target block within the reference layer as well as a ‘col block (collocated block)’ corresponding to the encoding/decoding target block within a ‘reconstructed neighboring block’ and an already reconstructed col picture (collocated picture), thereby improving encoding/decoding efficiency.

Here, the reconstructed neighboring block is a block within an reconstructed encoding/decoding target picture that is already encoded and/or decoded and may include a block adjacent to the encoding/decoding target block and/or a block positioned at an outside corner of the encoding/decoding target block. Further, the encoder and the decoder may determine a predetermined relative position based on a block existing at the same spatial position as that of the encoding/decoding target block within a collocated picture and derive the col block based on the determined predetermined relative position (position of the inside and/or the outside of a block existing at the same spatial position as that of the encoding/decoding target block). Here, as an example, the collocated picture may correspond to one picture of reference pictures included in a reference picture list.

Further, the reference layer block may be determined based on a position of a reference sample within the reference layer. As an example, the reference layer block may include a block including a position of the reference sample and/or a neighboring block positioned adjacent to a block including a position of the reference sample. In this case, the position of the reference sample may be derived based on a position of an enhancement reference sample belonging to the enhancement layer. The position of the enhancement reference sample may be determined as a relative position to the encoding/decoding target block. Detailed exemplary embodiments of a method of deriving a position of a reference sample based on a position of the enhancement reference sample and a method of deriving a reference layer block based on a position of the reference sample will be described later.

A method of deriving motion information may be changed according to a prediction mode of the encoding/decoding target block. A prediction mode applied for an inter prediction may include skip, an AMVP (Advanced Motion Vector Predictor), and merge. The encoder may determine an inter prediction mode, encode skip flag information representing whether a skip mode is applied and/or merge flag information representing whether a merge mode is applied, and transmit the encoded information to the decoder. In this case, the decoder may determine a prediction mode of the encoding/decoding target block based on the transmitted information.

As an example, when an AMVP is applied, the encoder and the decoder may generate an MVP (Motion Vector Predictor) candidate list using a motion vector of the reconstructed neighboring block, a motion vector of a co-located block and/or a motion vector of a reference layer block. That is, the motion vector of the reconstructed neighboring block, the motion vector of the co-located block and/or the motion vector of the reference layer block may be used as an MVP candidate.

When a plurality of MVP candidates are used, the encoder may select an optimal MVP of a plurality of MVP candidates included in the list based on rate-distortion optimization (RDO). In this case, the encoder may transmit an MVP index that indicates the selected optimal MVP to the decoder. In this case, the decoder may select a MVP of a decoding target block among a plurality of MVP candidates included in an MVP candidate list using the MVP index.

The encoder may obtain an MVD (Motion Vector Difference) between a motion vector of the encoding target block and an MVP, encode the MVD, and transmit the encoded MVD to the decoder. In this case, the decoder may decode the received MVD and derive a motion vector of the decoding target block through the sum of the decoded MVD and the MVP.

As another example, when merge is applied, the encoder and the decoder may generate a merge candidate list based on motion information of a reconstructed neighboring block, motion information of a co-located block and/or motion information of a reference layer block. That is, when motion information of the reconstructed neighboring block and the co-located block and/or motion information of the reference layer block exists, the encoder and the decoder may use the information as a merge candidate of the encoding/decoding target block. Here, merge may be referred to as motion information integration, and a merge candidate may be referred to as a motion information integration candidate.

When a plurality of merge candidates are used, the encoder may select a merge candidate that can provide optimal encoding efficiency among merge candidates included in a merge candidate list based on rate-distortion optimization (RDO) as motion information of an encoding target block. In this case, a merge index indicating the selected merge candidate may be included in bitstream, and the bitstream may be transmitted to the decoder. The decoder may select one of merge candidates included in the merge candidate list using the transmitted merge index and determine the selected merge candidate as motion information of the decoding target block. Therefore, when a merge mode is applied, motion information of the reconstructed neighboring block, the co-located block and/or the reference layer block may be used as motion information of the encoding/decoding target block.

The skip mode is a prediction mode that omits transmission of a residual signal, which is a difference between the encoding/decoding target block and a current block. In this case, as an example, motion information may be derived with the same method as that in a merge mode. Therefore, in a skip mode, the encoder may encode merge index information and transmit the encoded information to the decoder, and the decoder may derive motion information based on the transmitted merge index information.

Referring again to FIG. 4, the encoder and the decoder may perform motion compensation of the encoding/decoding target block based on the derived motion information and generate a prediction block corresponding to the encoding/decoding target block (S420). Here, the prediction block is a block generated by performing motion compensation of the encoding/decoding target block.

In an AMVP and merge mode, the encoder may generate a residual block corresponding to a difference between the encoding/decoding target block and the prediction block, encode information about the residual block, and transmit the encoded information to the decoder. The decoder may generate a residual block based on the transmitted information and add the generated residual block to the prediction block, thereby generating a reconstruction block. However, in a skip mode, a value of a residual signal between the encoding/decoding target block and the prediction block may be 0. Therefore, the encoder may not transmit syntax information such as a residual signal to the decoder.

According to the foregoing exemplary embodiment, in a merge mode and a skip mode, an inter prediction process (and/or a motion information deriving process) may be the same. Therefore, in the following exemplary embodiments, a merge mode may include the above-described merge mode and skip mode.

Further, hereinafter, in this specification, for convenience of description, the above-described MVP candidate and merge candidate are referred to as a ‘motion information candidate’. That is, in this specification, the ‘motion information candidate’ includes an MVP candidate and a merge candidate. Therefore, in this specification, an MVP candidate list and a merge candidate list are referred to a motion information candidate list.

As described above, when predicting inter layer motion information, the encoder and the decoder may determine a position of a reference sample within a reference layer based on a position of an enhancement reference sample. Further, the encoder and the decoder may determine a position of a ‘reference layer block’ for deriving a motion information candidate based on the position of the reference sample.

In this case, the position of the enhancement reference sample may be a relative position to the encoding/decoding target block (block belonging to the enhancement layer) and may be a predetermined fixed position as an example. In this case, a position of the reference sample derived from the encoding/decoding target block may be determined as one position corresponding to a position of the enhancement reference sample. Further, as an example, when predicting inter layer motion information, the encoder and the decoder may use only motion information of a reference layer block including the position of the reference sample as a motion information candidate, thereby encoding/decoding motion information of the encoding/decoding target block (block belonging to the enhancement layer).

However, in a scalable video encoding/decoding process based on a quad-tree structure, dependency of a coding structure between the enhancement layer and the reference layer may be low. Therefore, when a reference layer block is determined based on only a reference sample position corresponding to an enhancement reference sample of a predetermined fixed position or when only a block including a reference sample position is determined as a reference layer block, efficiency of an inter layer motion information prediction may be lowered based on motion information of the reference layer block.

Therefore, when predicting inter layer motion information, the encoder and the decoder may adaptively determine a position of a reference sample based on a position of a plurality of enhancement reference samples, thereby improving inter layer motion information prediction efficiency. In this case, a position of a reference sample determined for one encoding/decoding target block belonging to an enhancement layer may be variously determined according to a predetermined condition. Further, when a position of a reference sample is determined, the encoder and the decoder may use a neighboring block positioned at a periphery of a block including the position of the reference sample as well as a block including the position of the reference sample as a reference layer block. In this case, the encoder and the decoder may use motion information derived from the selected reference layer block as a motion information candidate (e.g., an MVP candidate and/or a merge candidate) in an AMVP process and/or a merge process, thereby improving encoding/decoding efficiency.

According to the above-described inter layer motion information prediction method, a decline of inter layer motion information prediction efficiency generating according to a difference in an image size between layers and a difference in a coding structure between layers may be minimized. Further, motion information of a reference layer block derived according to the above-described method is used as a motion information candidate (e.g., an MVP candidate and/or a merge candidate), thereby improving encoding/decoding efficiency.

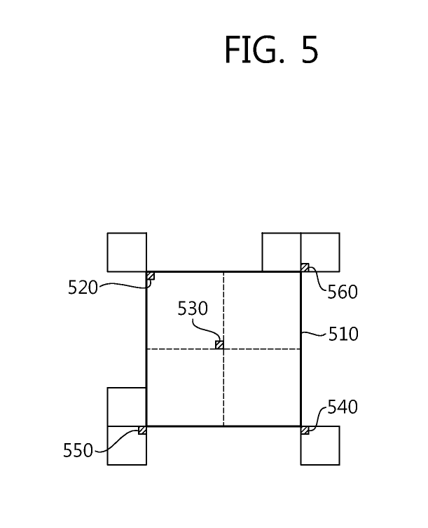

FIG. 5 is a diagram illustrating a method of deriving a position of a reference sample based on a position of an enhancement reference sample.

In an exemplary embodiment of FIG. 5, unless stated otherwise, the same method may be applied to a scalable video encoder (hereinafter, referred to as an encoder) and a scalable video decoder (hereinafter, referred to as a decoder). That is, the decoder determines a position of a reference sample with the same method as that in the encoder.

FIG. 5 illustrates exemplary embodiments of an encoding/decoding target block 510 belonging to an enhancement layer and an enhancement reference sample corresponding to the encoding/decoding target block 510. Here, the encoding/decoding target block 510 may be a block corresponding to one prediction unit as an example.

In an exemplary embodiment of FIG. 5, a width of the encoding/decoding target block 510, i.e., a width direction length of the encoding/decoding target block 510 may be represented by nPSW. Further, in the exemplary embodiment of FIG. 5, a height of the encoding/decoding target block 510, i.e., a vertical direction length of the encoding/decoding target block 510 may be represented by nPSH.

When sizes of input images (and/or input pictures) of the reference layer and the enhancement layer to which the encoding/decoding target block 510 belongs are different, a position of a reference sample corresponding to the enhancement reference sample may be derived based on a size ratio of an input image (and/or an input picture) of the enhancement layer and an input image (and/or an input picture) of the reference layer. Here, the size ratio may be represented with, for example, a scalingfactor and may be represented by Equation 1.

sf_{—}X=a horizontal size of an input image (and/or an input picture) of an enhancement layer/a horizontal size of an input image (and/or an input picture) of a reference layer

sf_{—}Y=a vertical size of an input image (and/or an input picture) of an enhancement layer/a vertical size of an input image (and/or an input picture) of a reference layer [Equation 1]

Here, sf_X may represent a size ratio of a horizontal direction, and sf_Y may represent a size ratio of a vertical direction.

As an example, when sizes of an input image (and/or an input picture) of the enhancement layer and an input image (and/or an input picture) of the reference layer are the same, an input image size ratio may be 1. Further, when a horizontal size of an input image (and/or an input picture) of the enhancement layer is double of a horizontal size of an input image (and/or an input picture) of the reference layer and a vertical size of an input image (and/or an input picture) of the enhancement layer is double of a vertical size of an input image (and/or an input picture) of the reference layer, an input image size ratio may be 2.

Further, in the following exemplary embodiments, (X, Y)/scalingfactor is obtained by dividing X and Y by a scalingfactor. That is, in the following exemplary embodiments, (X, Y)/scalingfactor is (X/scalingfactor, Y/scalingfactor). Further, when a horizontal direction size ratio (e.g., 2) and a vertical direction size ratio (e.g., 1.5) are different, (X, Y)/scalingfactor is (X/sf_X, Y/sf_Y).

Hereinafter, exemplary embodiments of an enhancement reference sample position corresponding to the encoding/decoding target block 510 and exemplary embodiments of a method of deriving a position of a reference sample based on a position of an enhancement reference sample are described.

Referring to FIG. 5, as an exemplary embodiment, the enhancement reference sample may be a left upper end sample 520 positioned at a leftmost upper end portion within the encoding/decoding target block 510. In this case, a leftmost upper end position within the encoding/decoding target block 510 may be represented by (xP, yP), xP may indicate an x-axis coordinate of the left upper end sample 520, and yP may indicate an y-axis coordinate of the left upper end sample 520. In this time, a position of a reference sample corresponding to the enhancement reference sample may be derived by Equation 2 as an example.

(refxP,refyP)=(xP,yP)/scalingfactor [Equation 2]

Here, refxP may represent an x-axis coordinate of a reference sample, and refyP may represent a y-axis coordinate of a reference sample.

As another exemplary embodiment, the enhancement reference sample may correspond to at least one of four center samples positioned at the center within the encoding/decoding target block 510.

As an example, the enhancement reference sample may be a left upper end center sample 530 positioned at a left upper end portion among the center samples. In this case, a position of the left upper end center sample 530 may be represented by Equation 3 as an example.

(xPCtr,yPCtr)=(xP+nPSW>>1)−1),yP+nPSH>>1)−1) [Equation 3]

Here, xPCtr may represent an x-axis coordinate of a center sample, and yPCtr may represent an y-axis coordinate of a center sample.

As another example, the enhancement reference sample may be a right lower end center sample positioned at a right lower end portion among the center samples. In this case, a position of the right lower end center sample may be represented by Equation 4 as an example.

(xPCtr,yPCtr)=(xP+nPSW>>1),yP+nPSH>>1) [Equation 4]

As another example, the enhancement reference sample may be a left lower end center sample positioned at a left lower end portion among the center samples. In this case, a position of the left lower end center sample may be represented by Equation 5 as an example.

(xPCtr,yPCtr)=(xP+nPSW>>1)−1),yP+nPSH>>1) [Equation 5]

As another example, the enhancement reference sample may be a right upper end center sample positioned at a right upper end portion among the center samples. In this case, a position of the right upper end center sample may be represented by Equation 6 as an example.

(xPCtr,yPCtr)=(xP+nPSW>>1,yP+nPSH>>1)−1) [Equation 6]

When the center sample is used as an enhancement reference sample, a position of a reference sample corresponding to the enhancement reference sample may be derived by Equation 7 as an example.

(refxP,refyP)=(xPCtr,yPCtr)/scalingfactor [Equation 7]

As another exemplary embodiment, the enhancement reference sample may be a right lower end corner sample 540 positioned most adjacent to a right lower end corner of the outside of the encoding/decoding target block 510. In this case, a position of the right lower end corner sample 540 may be represented by Equation 8 as an example.

(xPRb,yPRb)=(xP+nPSW,yP+nPSH) [Equation 8]

Here, xPRb may represent an x-axis coordinate of the right lower end corner sample 540, and yPRb may represent an y-axis coordinate of the right lower end corner sample 540. In this case, a position of a reference sample corresponding to the enhancement reference sample may be derived by Equation 9 as an example.

(refxP,refyP)=(xPRb,yPRb)/scalingfactor [Equation 9]

As another exemplary embodiment, the enhancement reference sample may be a left lower end corner sample 550 positioned most adjacent to a left lower end corner of the outside of the encoding/decoding target block 510. In this case, a position of the left lower end corner sample 550 may be represented by Equation 10 as an example.

(xPLb,yPLb)=(xP−1,yP+nPSH) [Equation 10]

Here, xPLb may represent an x-axis coordinate of the left lower end corner sample 550, and yPLb may represent an y-axis coordinate of the left lower end corner sample 550. In this case, a position of a reference sample corresponding to the enhancement reference sample may be derived by Equation 11 as an example.

(refxP,refyP)=(xPLb,yPLb)/scalingfactor [Equation 11]

As another exemplary embodiment, the enhancement reference sample may be a right upper end corner sample 560 positioned most adjacent to a right upper end corner of the outside of the encoding/decoding target block 510. In this case, a position of the right upper end corner sample 560 may be represented by Equation 12 as an example.

(xPRt,yPRt)=(xP+nPSH,yP−1) [Equation 12]

Here, xPRt may represent an x-axis coordinate of the right upper end corner sample 560, and yPRt may represent an y-axis coordinate of the right upper end corner sample 560. In this case, a position of a sample reference sample corresponding to the enhancement reference sample may be derived by Equation 13 as an example.

(refxP,refyP)=(xPRt,yPRt)/scaling factor [Equation 13]

In FIG. 5, exemplary embodiments of a case in which the left upper end sample 520, the left upper end center sample 530, the right lower end corner sample 540, the left lower end corner sample 550 and/or the right upper end corner sample 560 are used as an enhancement reference sample are described, but the present invention is not limited thereto. That is, the encoder and the decoder use samples of various positions that are not shown in FIG. 5 as well as samples of a position shown in FIG. 5 as an enhancement reference sample. In this case, a position of a reference sample corresponding to each enhancement reference sample is derived with a method similar to that in the foregoing exemplary embodiment. For example, when a position of an enhancement reference sample existing at a random position is (xPk, yPk) (e.g., (xP+1, yP+1)), a position of a reference sample corresponding to the enhancement reference sample may be represented by Equation 14.

(refxP,refyP)=(xPk,yPk)/scaling factor [Equation 14]

The encoder and the decoder may determine at least one of a plurality of samples including a sample of another position that is not shown in FIG. 5 as well as a sample shown in FIG. 5 as an enhancement reference sample corresponding to the encoding/decoding target block 510. In this case, the encoder and the decoder may adaptively determine a position of a reference sample based on a position of at least one enhancement reference sample, thereby improving inter layer motion information prediction efficiency. A method of deriving a position of a reference sample corresponding to each enhancement reference sample has been described above and thus a description thereof will be omitted.

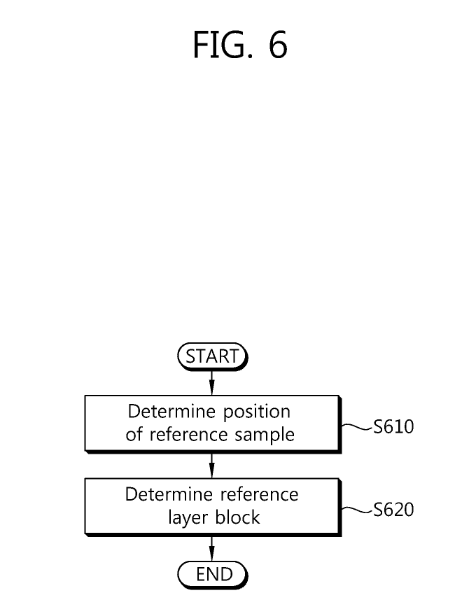

FIG. 6 is a flowchart illustrating a method of determining a reference layer block according to an exemplary embodiment of the present invention.

In an exemplary embodiment of FIG. 6, unless stated otherwise, the same method may be applied to a scalable video encoder (hereinafter, referred to as an encoder) and a scalable video decoder (hereinafter, referred to as a decoder). That is, the decoder may determine a reference layer block with the same method as that in the encoder. Further, in an exemplary embodiment of FIG. 6, unless stated otherwise, the same method or a similar method may be applied in an AMVP process and a merge process.

Referring to FIG. 6, the encoder and the decoder may determine a position of a reference sample based on a position of an enhancement reference sample corresponding to an encoding/decoding target block belonging to an enhancement layer (S610). Here, as an example, the encoding/decoding target block may be a block corresponding to one prediction unit. In this case, as described above, the encoder and the decoder may adaptively determine a position of a reference sample based on a position of one or more enhancement reference sample. In this case, a reference sample corresponding to each enhancement reference sample may be one.

As an example, the encoder and the decoder may determine only a position of one reference sample based on one enhancement reference sample existing at a predetermined position. However, as another example, the encoder and the decoder may determine a position of a reference sample corresponding to each of a plurality of enhancement reference samples existing at a predetermined position, thereby determining a position of a plurality of reference samples. Exemplary embodiments of an enhancement reference sample used for determining a position of a reference sample has been described in relation to FIG. 5 and therefore a description thereof will be omitted.

A block (e.g., the block may be a block corresponding to a prediction unit) including the determined position of the reference sample may be an encoded/decoded block (hereinafter, referred to as an intra block) in an intra mode or an unavailable block. In this case, the block may not include available motion information. Therefore, in this case, the encoder and the decoder may use a sample having a position different from that of an enhancement reference sample corresponding to the determined reference sample as an enhancement reference sample and determine a position of a new reference sample based on the sample (enhancement reference sample) of the different position. In this case, a newly determined reference sample (and/or a position of a reference sample) may be used for determining a reference layer block instead of a previously determined reference sample (and/or a position of a reference sample).

Referring again to FIG. 6, the encoder and the decoder may determine one or more reference layer block based on a position of the reference sample (S620).

As described above, motion information of the reference layer block may be used as a motion information candidate of an encoding/decoding target block belonging to an enhancement layer in an AMVP process and/or a merge process.

In this case, as an exemplary embodiment, motion information of the reference layer block may be used as an additional motion information candidate together with a motion information candidate derived from a reconstructed neighboring block (here, the reconstructed neighboring block includes a block adjacent to an encoding/decoding target block and/or a block positioned at an external corner of an encoding/decoding target block) and a motion information candidate derived from a col block. Here, a motion information candidate derived from a reconstructed neighboring block and a motion information candidate derived from a col block may correspond to a motion information candidate derived within an enhancement layer. In this case, a motion information candidate list (e.g., an MVP candidate list and/or a merge candidate list) may include all of a motion information candidate derived from a reconstructed neighboring block, a motion information candidate derived from a col block, and a motion information candidate derived from a reference layer block.

In the foregoing exemplary embodiment, a reconstructed neighboring block corresponding to the encoding/decoding target block and/or a col block corresponding to the encoding/decoding target block may be an encoded/decoded block (hereinafter, referred to as an intra block) in an intra mode or an unavailable block. In this case, the blocks may not include available motion information. Therefore, in this case, the encoder and the decoder may derive a motion information candidate corresponding to an encoding/decoding target block based on a block existing at the same position as that of the reconstructed neighboring block and/or the col block within a reference layer. In this case, in a motion information candidate list, a position (and/or an order) of the derived motion information candidate may be the same as a position (and/or an order) of a motion information candidate derived when the reconstructed neighboring block and/or the co-located block is available.

Hereinafter, when motion information of a reference layer block is used as an additional motion information candidate together with a motion information candidate derived from the reconstructed neighboring block and a motion information candidate derived from a col block, exemplary embodiments of a reference layer block determining process are described.

As described above, the encoder and the decoder may determine a position of a reference sample corresponding to each of a plurality of enhancement reference samples, thereby determining a position of a plurality of reference samples. For example, the encoder and the decoder may determine positions of reference samples of each of the n number (n is the natural number) of enhancement reference sample positions. In this case, the determined position of the reference sample may be the n number. In this case, the encoder and the decoder may determine a block (e.g., a block corresponding to a prediction unit) including a position of each reference sample as a reference layer block. Here, the reference layer block may include at least one reference sample, and the number of reference layer blocks determined based on the n number of reference samples may be the maximum n number. Therefore, in this case, motion information of a plurality of reference layer blocks may be used as a motion information candidate.

As in the foregoing exemplary embodiment, the encoder and the decoder may determine only a block (hereinafter, referred to as a first block, and the first block may be a block corresponding to a prediction unit as an example) including a position of a reference sample as a reference layer block, but a block (hereinafter, referred to as a second block, and the second block may be a block corresponding to a prediction unit as an example) positioned at a periphery of a block including a position of a reference sample may be determined as a reference layer block together with the first block. In this case, the second block may include a block positioned adjacent to the first block and a block positioned at an external corner of the first block. In this case, the number of reference layer blocks determined based on one reference sample may be the plural number. Therefore, even when one reference sample is used as well as when a plurality of reference samples are used, the encoder and the decoder may derive a plurality of reference layer blocks (e.g., the n number). In this case, a plurality of motion information (e.g., the n number) derived from a plurality of reference layer blocks (e.g., the n number) may be used as a motion information candidate.

The first block may be an intra block or an unavailable block. In this case, the block may not include available motion information. In this case, the encoder and the decoder may determine a position of a new reference sample, as described above, in a process of determining a reference sample position (S610) and use a block including a newly determined position of a reference sample as a reference layer block. However, the encoder and the decoder may not determine a new position of the reference sample and use motion information of a second block positioned at a periphery of the first block as a motion information candidate of the encoding/decoding target block. That is, the second block may be determined as a reference layer block in a condition that the first block is an intra block or an unavailable block.

In the foregoing exemplary embodiments, at least one block of a first block (here, the first block may include a plurality of blocks derived to correspond to a plurality of reference samples) including a position of a reference sample and a second block (here, the second block may include a plurality of blocks) positioned at a periphery of the first block may be determined as a reference layer block. In this case, motion information of each of the reference layer blocks may be used as a motion information candidate of the encoding/decoding target block together with a motion information candidate (a motion information candidate derived from a reconstructed neighboring block positioned at a peripheral of the encoding/decoding target block and a motion information candidate derived from a col block) derived within an enhancement layer in an AMVP process and a merge process.

In this case, a motion information candidate derived within the enhancement layer and a motion information candidate derived from a reference layer block may be included in and/or inserted into a motion information candidate list according to a predetermined priority. As an example, the encoder and the decoder may preferentially insert a motion information candidate derived within the enhancement layer into a motion information candidate list and insert a motion information candidate derived from a reference layer block into the motion information candidate list. In this case, a lower index (e.g., an MVP index and/or a merge index) value is allocated to a motion information candidate derived within the enhancement layer. As another example, the encoder and the decoder may preferentially insert a motion information candidate derived from the reference layer block into the motion information candidate list and insert a motion information candidate derived within the enhancement layer into a motion information candidate list. In this case, a lower index (e.g., an MVP index and/or a merge index) value is allocated to a motion information candidate list derived from the reference layer block.

As an example, when an AMVP is applied, as described above in relation to FIG. 4, the encoder may encode prediction direction information, reference picture index information, MVD information, and MVP index information and transmit the information to the decoder. In this case, the decoder may receive and decode the transmitted information. The decoder may select an MVP of a decoded target block among a plurality of MVP candidates included in an MVP candidate list based on the decoded MVP index information. The decoder may generate a prediction block corresponding to a decoding target block based on the selected MVP, decoded MVD information, decoded reference picture index information, and decoded prediction direction information.

As another example, when merge is applied, as described above in relation to FIG. 4, the encoder may encode merge index information and transmit the encoded information to the decoder. When merge is applied, the encoder may not transmit prediction direction information, reference picture index information, and MVD information to the decoder, unlike in an AMVP process. In this case, the decoder may receive and decode the transmitted merge index information. The decoder may determine a merge candidate to be used for deriving motion information of a decoding target block among a plurality of merge candidates included in a merge candidate list based on the decoded merge index information. In this case, the decoder may use motion information corresponding to the determined merge candidate as motion information of a decoding target block.

In the foregoing exemplary embodiments, it is described that a second block includes blocks positioned at a periphery of a first block including a position of a reference sample, but the second block may be limited by a predetermined reference. As an example, the encoder and the decoder may determine only a block corresponding to an immediately previous order of a first block in a z-scan order as a second block. In this case, the same method as or a similar method to that of the foregoing exemplary embodiments may be applied to the determined second block.

As another exemplary embodiment, the encoder and the decoder may use only motion information of the reference layer block as a motion information candidate corresponding to the encoding/decoding target block. In this case, a motion information candidate list (e.g., an MVP candidate list and/or a merge candidate list) used in an AMVP process and a merge process may include only a motion information candidate derived from the reference layer block. In this case, a process of deriving a motion information candidate within the enhancement layer, i.e., a process of deriving a motion information candidate from a reconstructed neighboring block (here, the reconstructed neighboring block includes a block adjacent to the encoding/decoding target block and/or a block positioned at an outside corner of the encoding/decoding target block) and a process of deriving a motion information candidate from a col block may be omitted. Hereinafter, when only motion information of the reference layer block is used as a motion information candidate corresponding to the encoding/decoding target block, exemplary embodiments of a reference layer block determining process are described.

As described above, the encoder and the decoder may determine a position of a reference sample corresponding to each of a plurality of enhancement reference samples, thereby determining a position of a plurality of reference samples. For example, the encoder and the decoder may determine a position of a reference sample of each of the n number (n is the natural number) of enhancement reference samples. In this case, the determined position of the reference sample may be the n number. In this case, the encoder and the decoder may determine a block (e.g., a block corresponding to a prediction unit) including a position of each reference sample as a reference layer block. Here, the reference layer block may include at least one reference sample, and the number of reference layer blocks determined based on the n number of reference samples may be the maximum n number. Therefore, in this case, motion information of a plurality of reference layer blocks may be used as a motion information candidate.

As in the foregoing exemplary embodiment, the encoder and the decoder may determine only a block (hereinafter, referred to as a ‘first block’, and the first block may be a block corresponding to a prediction unit as an example) including a position of the reference sample as a reference layer block, but a block (hereinafter, referred to as a ‘second block’, and the second block may be a block corresponding to a prediction unit as an example) positioned at a periphery of a block including a position of the reference sample together with the first block may be determined as a reference layer block. In this case, the second block may include a block positioned adjacent to the first block and a block positioned at an outside corner of the first block. In this case, the number of reference layer blocks determined based on one reference sample may be the plural number. Therefore, even when one reference sample is used as well as when a plurality of reference samples are used, the encoder and the decoder may derive a plurality of reference layer blocks (e.g., the n number). In this case, a plurality of motion information (e.g., the n number) derived from a plurality of reference layer blocks (e.g., the n number) may be used as a motion information candidate.

A first block may be an intra block or an unavailable block. In this case, the block may not include available motion information. In this case, as described above, in a process (S610) of determining a position of a reference sample, the encoder and the decoder may determine a position of a new reference sample and use a block including the determined position of the new reference sample as a reference layer block. However, the encoder and the decoder may use motion information of a second block positioned at a periphery of the first block as a motion information candidate of the encoding/decoding target block without determining a position of the new reference sample. That is, the second block may be determined as a reference layer block in a condition that the first block is an intra block or an unavailable block.

In the foregoing exemplary embodiments, at least one block of a first block (here, the first block includes a plurality of blocks derived to correspond to a plurality of reference samples) including a position of the reference sample and a second block (here, the second block may include a plurality of blocks) positioned at a periphery of the first block may be determined as a reference layer block. In this case, motion information of each of reference layer blocks may be used as a motion information candidate of the encoding/decoding target block belonging to an enhancement layer in an AMVP process and a merge process. Further, as described above, in an AMVP process and/or a merge process, the encoder and the decoder may use only motion information of the reference layer block as a motion information candidate corresponding to the encoding/decoding target block. In this time, a motion information candidate list (e.g., an MVP candidate list and/or a merge candidate list) may include only a motion information candidate derived from the reference layer block.

As an example, when AMVP is applied, as described in relation to FIG. 4, the encoder may encode prediction direction information, reference picture index information, and MVD information and transmit the encoded information to the decoder. Further, when the number of an MVP candidate derived from the reference layer is two or more, the encoder may encode MVP index information and transmit the encoded information to the decoder. In this case, the decoder may receive and decode the transmitted information. When the MVP index information is transmitted from the encoder to the decoder, the decoder may select an MVP of a decoding target block among a plurality of MVP candidates included in an MVP candidate list based on the MVP index information. The decoder may generate a prediction block corresponding to a decoding target block based on the selected MVP, decoded MVD information, decoded reference picture index information, and decoded prediction direction information.

As another example, when merge is applied, the encoder may not transmit prediction direction information, reference picture index information, and MVD information to the decoder, unlike in an AMVP process. However, when the number of merge candidates derived from the reference layer is two or more, the encoder may encode merge index information and transmit the merge index information to the decoder. When the merge index information is encoded and transmitted from the encoder to the decoder, the decoder may receive and decode the transmitted merge index information. The decoder may determine a merge candidate to be used for deriving motion information of a decoding target block among a plurality of merge candidates included in a merge candidate list based on the decoded merge index information. In this case, the decoder may use motion information corresponding to the determined merge candidate as motion information of a decoding target block.

In the foregoing exemplary embodiments, it is described that a second block includes blocks positioned at a periphery of a first block including a position of a reference sample, but the second block may be limited by a predetermined reference. As an example, the encoder and the decoder may determine only a block corresponding to an immediately previous order of a first block in a z-scan order as a second block. In this case, the same method as or a method similar to the foregoing exemplary embodiments may be applied to the determined second block.

Further, in the foregoing exemplary embodiment, only motion information of the reference layer block may be used as a motion information candidate corresponding to the encoding/decoding target block. In this case, as an example, a mode that uses only motion information of the reference layer block as a motion information candidate corresponding to the encoding/decoding target block may be defined as a new prediction mode. In this case, the encoder may transmit information about the prediction mode to the decoder, and the decoder may use only motion information of the reference layer block as a motion information candidate of the encoding/decoding target block based on the transmitted information. As another example, the encoder may transmit flag information indicating that only motion information of the reference layer block is used as a motion information candidate corresponding to the encoding/decoding target block to the decoder. In this case, the decoder may use only motion information of the reference layer block as a motion information candidate of the encoding/decoding target block based on the flag information.

In an exemplary embodiment of FIG. 6, as described above, a size of an input image (and/or an input picture) of the enhancement layer to which the encoding/decoding target block belongs and a size of an input image (and/or an input picture) of the reference layer may be different. In this case, the encoder and the decoder may determine motion information of the encoding/decoding target block based on a size ratio between an input image (and/or an input picture) of the enhancement layer and an input image (and/or an input picture) of the reference layer. That is, the encoder and the decoder may derive a motion information candidate of the encoding/decoding target block by applying the size ratio to motion information of the reference layer block. Here, the size ratio may be represented with, for example, a scalingfactor.

A size ratio value between an input image (and/or an input picture) of the enhancement layer and an input image of the reference layer (and/or an input picture) may correspond to, for example, a value that divides a size of an input image (and/or an input picture) of the enhancement layer by a size of an input image of the reference layer (and/or an input picture). In this case, the encoder and the decoder may determine a value that multiplies the size ratio to a motion information value of the reference layer block as a motion information candidate value of the encoding/decoding target block belonging to the enhancement layer. For example, a size of an input image (and/or an input picture) of the enhancement layer may correspond to the double of a size of an input image (and/or an input picture) of the reference layer. In this case, a value of the size ratio (e.g., a scalingfactor) may be 2. In this case, the encoder and the decoder may derive a motion information candidate value of the encoding/decoding target block by multiplying 2 to a motion information value of the reference layer block.

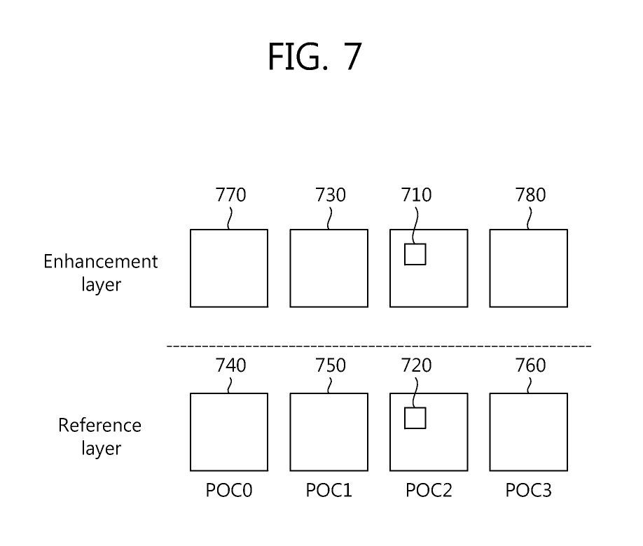

In an AMVP process, the encoder and the decoder may derive an MVP candidate (and/or a motion vector of the encoding/decoding target block) corresponding to a reference layer block, based on a first temporal distance from the encoding/decoding target block to a first reference picture in which the encoding/decoding target block refers when performing an inter prediction and a second temporal distance from the reference layer block to a second reference picture in which the reference layer block refers when performing an inter prediction. Further, in a merge process, the encoder and the decoder may determine motion information (and/or a merge candidate corresponding to the reference layer block) of the encoding/decoding target block based on a POC value of a second reference picture in which the reference layer block refers when performing an inter prediction. Here, the POC may represent a value allocated to each picture according to a display order of a picture. A detailed exemplary embodiment thereof will be described later with reference to FIG. 7.

FIG. 7 is a diagram illustrating an exemplary embodiment of a method of deriving a motion information candidate in an AMVP mode and a merge mode. In an exemplary embodiment of FIG. 7, unless stated otherwise, the same method may be applied to a scalable video encoder (hereinafter, referred to as an encoder) and a scalable video decoder (hereinafter, referred to as a decoder).

In FIG. 7, a plurality of pictures belonging to an enhancement layer and a plurality of pictures belonging to a reference layer are shown in a POC order. In an exemplary embodiment of FIG. 7, a block 710 may represent an encoding/decoding target block, and a block 720 may represent a reference layer block corresponding to the encoding/decoding target block.

As an exemplary embodiment, when an AMVP is applied, as described above, the encoder and the decoder may derive an MVP candidate (and/or a motion vector of an encoding/decoding target block) corresponding to a reference layer block, based on a first temporal distance from an encoding/decoding target block to a first reference picture in which the encoding/decoding target block refers when performing an inter prediction and a second temporal distance from the reference layer block to a second reference picture in which the reference layer block refers when performing an inter prediction. As an example, when the first temporal distance and the second temporal distance are the same, the encoder and the decoder may determine a motion vector of a reference layer block as an MVP candidate (and/or a motion vector of an encoding/decoding target block). As another example, when the first temporal distance and the second temporal distance are not the same, the encoder and the decoder may scale a motion vector of a reference layer block based on a temporal distance ratio between the first temporal distance and the second temporal distance, thereby deriving an MVP candidate (and/or a motion vector of an encoding/decoding target block) corresponding to the reference layer block.

As an example, in an exemplary embodiment of FIG. 7, it is assumed that a first reference picture in which the encoding/decoding target block 710 refers is a picture 730, and a second reference picture in which the reference layer block 720 refers is a picture 750. In this case, because a POC value of the first reference picture 730 and a POC value of the second reference picture 750 are the same, a first temporal distance from the encoding/decoding target block 710 to the first reference picture 730 and a second temporal distance from the reference layer block 720 to the second reference picture 750 may be the same. Therefore, the encoder and the decoder may use a motion vector of the reference layer block 720 as an MVP candidate (and/or a motion vector of an encoding/decoding target block) of an encoding/decoding target block.

As another example, in an exemplary embodiment of FIG. 7, it is assumed that a first reference picture in which the encoding/decoding target block 710 refers is a picture 730 and a second reference picture in which the reference layer block 720 refers is a picture 740. In this case, because a POC value of the first reference picture 730 and a POC value of the second reference picture 740 are the same, a first temporal distance from the encoding/decoding target block 710 to the first reference picture 730 and a second temporal distance from the reference layer block 720 to the second reference picture 740 may be different. In this case, the encoder and the decoder may scale a motion vector of a reference layer block based on a temporal distance ratio between the first temporal distance and the second temporal distance, thereby deriving an MVP candidate (and/or a motion vector of an encoding/decoding target block) corresponding to the reference layer block. Here, because the first temporal distance is ½ of the second temporal distance, as an example, the encoder and the decoder may determine a value that multiplies ½ to a motion vector value of the reference layer block 720 as a value of an MVP candidate (and/or a motion vector of the encoding/decoding target block).

As another example, in an exemplary embodiment of FIG. 7, it is assumed that a first reference picture in which the encoding/decoding target block 710 refers is a picture 730 and a second reference picture in which the reference layer block 720 refers is a picture 760. In this case, because a POC value of the first reference picture 730 and a POC value of the second reference picture 760 are not the same, a first temporal distance from the encoding/decoding target block 710 to the first reference picture 730 and a second reference picture from the reference layer block 720 to the second reference picture 760 may be different. In this case, the encoder and the decoder may scale a motion vector of a reference layer block based on a temporal distance ratio between the first temporal distance and the second temporal distance, thereby deriving an MVP candidate (and/or a motion vector of the encoding/decoding target block) corresponding to the reference layer block. Here, because the first temporal distance has a value that multiplies −1 to the second temporal distance, as an example, the encoder and the decoder may determine a value that multiplies −1 to a motion vector value of the reference layer block 720 as a value of an MVP candidate (and/or a motion vector of the encoding/decoding target block).

In the foregoing exemplary embodiments, the first temporal distance may correspond to a difference value between a POC value of the encoding/decoding target block 710 and a POC value of the first reference picture. Further, the second temporal distance may correspond to a difference value between a POC value of the reference layer block 720 and a POC value of the second reference picture.

As another exemplary embodiment, when merge is applied, as described above, the encoder and the decoder may determine motion information (and/or a merge candidate corresponding to the reference layer block) of the encoding/decoding target block based on a POC value of a second reference picture in which the reference layer block refers when performing an inter prediction. Here, the POC may represent a value allocated to each picture in a display order of a picture.

For example, the encoder and the decoder may determine a reference picture index of the encoding/decoding target block based on a POC value of the second reference picture. In this case, the reference picture index may indicate a picture within an enhancement layer having the same POC value as a POC value of the second reference picture. That is, the encoder and the decoder may use a picture within an enhancement layer having the same POC value as the POC value of the second reference picture as a first reference picture corresponding to the encoding/decoding target block. Further, the encoder and the decoder may determine a motion vector of the encoding/decoding target block based on a motion vector of the reference layer block or the second reference picture.

As another example, the encoder and the decoder may determine a merge candidate corresponding to a reference layer block based on a POC value of the second reference picture. In this case, when the merge candidate is determined as motion information of the encoding/decoding target block, a reference picture index corresponding to the merge candidate may indicate a first reference picture in which the encoding/decoding target block refers when performing an inter prediction. In this case, the first reference picture may correspond to a picture having the same POC value as a POC value of the second reference picture. Further, the encoder and the decoder may determine a motion vector corresponding to the merge candidate based on a motion vector of a reference layer block or a second reference picture.

Hereinafter, the following exemplary embodiments are described from a motion information determination viewpoint of the encoding/decoding target block, but even when deriving a merge candidate corresponding to a reference layer block, the same or similar method may be applied.

As an example, it is assumed that a second reference picture in which the reference layer block 720 refers is a picture 740. In this case, the encoder and the decoder may determine a reference picture index that indicates a picture 770 having the same POC value as that of the second reference picture 740 as a reference picture index of the encoding/decoding target block 710. In this case, the picture 770 may be used as a first reference picture corresponding to the encoding/decoding target block 710. Further, the encoder and the decoder may determine a motion vector of the reference layer block 720 or the second reference picture 740 as a motion vector of the encoding/decoding target block 710.

As another example, it is assumed that a second reference picture in which the reference layer block 720 refers is a picture 760. In this case, the encoder and the decoder may determine a reference picture index that indicates a picture 780 having the same POC value as that of the second reference picture 760 as a reference picture index of the encoding/decoding target block 710. In this case, the picture 780 may be used as a first reference picture corresponding to the encoding/decoding target block 710. Further, the encoder and the decoder may determine a motion vector of the reference layer block 720 or the second reference picture 760 as a motion vector of the encoding/decoding target block 710.

As another example, it is assumed that a second reference picture in which the reference layer block 720 refers is two, and the two second reference pictures are a picture 740 and a picture 760. In this case, a bi-direction prediction of the reference layer block 720 may be performed. In this case, the encoder and the decoder may determine a reference picture index that indicates a picture 770 having the same POC value as that of the second reference picture 740 and a reference picture index that indicates a picture 780 having the same POC value as that of the second reference picture 760 as a reference picture index of the encoding/decoding target block 710. In this case, the picture 770 and the picture 780 may be used as a first reference picture corresponding to the encoding/decoding target block 710. Further, the encoder and the decoder may determine a motion vector of the reference layer block 720 as a motion vector of the encoding/decoding target block 710 or determine a motion vector of the picture 740 and the picture 760 as a motion vector of the encoding/decoding target block 710.

In exemplary embodiments of FIGS. 5 to 7, a motion information candidate corresponding to an encoding/decoding target block may be derived based on motion information of the reference layer block. In this case, as an example, it may be determined based on separate flag information whether a motion information candidate derived from the reference layer block is used as a motion information candidate of the encoding/decoding target block. That is, the encoder and the decoder may adaptively (or variably) determine based on the flag information whether motion information of a reference layer block is used. Here, the flag information may be transmitted in video parameter sets (VPS), sequence parameter sets (SPS), Picture Parameter Sets (PPS), a slice header, or a coding unit.

In the foregoing exemplary embodiments, methods are described based on a flowchart with a series of steps or blocks, but the present invention is not limited to order of steps, and some step may occur with steps and orders different from the above-described step or may simultaneously occur. Further, it will be understood by those skilled in the art that steps illustrated in a flowchart are not limited and other steps are included or one or more step of a flowchart may be deleted without influencing on a range of the present invention.

The foregoing exemplary embodiment includes various aspects of illustrations. Although all possible combinations for representing various aspects may not be described, a person of ordinary skill in the art may recognize that another combination is possible. Therefore, it will be understood by those skilled in the art that various changes in form and details may be made therein without departing from the spirit and scope of the invention as defined by the appended claims.

What is claimed is:

1. A method of performing an inter layer prediction, the method comprising:
determining a position of a reference sample corresponding to an enhancement reference sample within a reference layer, based on a position of the enhancement reference sample that belongs to an enhancement layer;
determining at least one reference layer block in the reference layer based on the position of the reference sample; and
performing a prediction of a current block that belongs to the enhancement layer, based on motion information of the at least one reference layer block,
wherein the position of the enhancement reference sample is determined as a relative position of the current block, and
the position of the reference sample corresponding to the enhancement reference sample is determined based on an input picture size ratio between an input picture of the enhancement layer and an input picture of the reference layer.

2. The method of claim 1, wherein the enhancement reference sample comprises at least one of a left upper end sample positioned at a leftmost upper end portion of the inside of the current block, a left upper end center sample positioned at a left upper end portion among four samples positioned at the center of the inside of the current block, a right lower end corner sample positioned most adjacent to a right lower end corner of the outside of the current block, a left lower end corner sample positioned most adjacent to a left lower end corner of the outside of the current block, and a right upper end corner sample positioned most adjacent to a right upper end corner of the outside of the current block.

3. The method of claim 1, wherein at the determining of at least one reference layer block,
at least one of a first block comprising the position of the reference sample and a second block positioned at a periphery of the first block is determined as the reference layer block, and
the second block comprises at least one of blocks positioned adjacent to the first block and blocks positioned most adjacent to a corner of the outside of the first block.

4. The method of claim 1, wherein at the determining of at least one reference layer block,
when a first block comprising the position of the reference sample is unavailable or when a prediction mode of the first block is an intra mode,
a second block positioned at a periphery of the first block is determined as the reference layer block, and
the second block comprises at least one of blocks positioned adjacent to the first block and blocks positioned most adjacent to a corner of the outside of the first block.

5. The method of claim 1, wherein at the determining of at least one reference layer block,
when a first block comprising the position of the reference sample is unavailable or when a prediction mode of the first block is an intra mode,
a second block comprising a position of another sample, not the reference sample within the reference layer is determined as the reference layer block, and
the position of another sample, not the reference sample is determined based on a sample of a position different from the enhancement reference sample corresponding to the reference sample among samples within the enhancement layer.

6. The method of claim 1, wherein the performing of the prediction comprises:
receiving image information comprising a motion vector predictor (MVP) index and a motion vector difference (MVD);
generating an MVP candidate list comprising a plurality of MVP candidates based on motion information of the at least one reference layer block;
determining an MVP of the current block based on the MVP index and the MVP candidate list;
deriving a motion vector of the current block by adding the determined MVP and the MVD; and
performing a prediction of the current block based on the derived motion vector,
wherein the MVP index indicates an MVP candidate to be used as an MVP of the current block among a plurality of MVP candidates constructing the MVP candidate list, and
the MVD is a difference value between the motion vector of the current block and the MVP of the current block.

7. The method of claim 6, wherein at the generating of the MVP candidate list,
an MVP candidate corresponding to each of motion information of the at least one reference layer block is derived based on the input picture size ratio.

8. The method of claim 6, wherein the MVP candidate list comprises at least one of a first MVP candidate derived based on a reconstructed neighboring block, a second MVP candidate derived based on a co-located block, and a third MVP candidate derived based on the at least one reference layer block,
the reconstructed neighboring block comprises at least one of blocks positioned adjacent to the current block and blocks positioned most adjacent to a corner of the outside of the current block, and
the co-located block is one of a plurality of blocks constructing a reference picture, not a current picture to which the current block belongs.

9. The method of claim 8, wherein the first MVP candidate is derived based on a motion vector of a block existing at the same spatial position as that of the reconstructed neighboring block within the reference layer, when the reconstructed neighboring block is unavailable or when a prediction mode of the reconstructed neighboring block is an intra mode.

10. The method of claim 8, wherein an MVP index value smaller than that of the first MVP candidate and the second MVP candidate is allocated to the third MVP candidate.

11. The method of claim 8, wherein the third MVP candidate is derived by scaling motion information of the at least one reference layer block, based on a first temporal distance from the current block to a first reference picture in which the current block refers when performing an inter prediction, and a second temporal distance from the at least one reference layer block to a second reference picture in which the at least one reference layer block refers when performing an inter prediction, and
the first reference picture is a block belonging to the enhancement layer, and the second reference picture is a block belonging to the reference layer.

12. The method of claim 1, wherein the performing of the prediction further comprises:
receiving image information comprising a merge index;
generating a merge candidate list comprising a plurality of merge candidates based on motion information of the at least one reference layer block;
determining motion information of the current block based on the merge index and the merge candidate list; and
performing a prediction of the current block based on the determined motion information,
the merge index indicates a merge candidate to be used as motion information of the current block among a plurality of merge candidates constructing the merge candidate list.

13. The method of claim 12, wherein at the generating of the merge candidate list,
a merge candidate corresponding to each of motion information of the at least one reference layer block is derived based on the input picture size ratio.

14. The method of claim 12, wherein the merge candidate list comprises at least one of a first merge candidate derived based on a reconstructed neighboring block, a second merge candidate derived based on a co-located block, and a third merge candidate derived based on the at least one reference layer block,
the reconstructed neighboring block comprises at least one of blocks positioned adjacent to the current block and blocks positioned most adjacent to a corner of the outside of the current block, and
the co-located block is one of a plurality of blocks constructing a reference picture, not a current picture to which the current block belongs.

15. The method of claim 14, wherein the first merge candidate is derived based on a motion vector of a block existing at the same spatial position as that of the reconstructed neighboring block within the reference layer, when the reconstructed neighboring block is unavailable or when a prediction mode of the reconstructed neighboring block is intra mode.

16. The method of claim 14, wherein a merge index value smaller than that of the first merge candidate and the second merge candidate is allocated to the third merge candidate.

17. The method of claim 14, wherein the generating of the merge candidate list comprises determining a reference picture index corresponding to the third merge candidate,
wherein the reference picture index indicates a first reference picture in which the current block refers when performing an inter prediction, when the third merge candidate is determined as motion information of the current block,
the first reference picture is a picture having the same picture order count (POC) value as a POC value of a second reference picture in which the at least one reference layer block refers when performing an inter prediction, and
the first reference picture is a picture belonging to the enhancement layer, and the second reference picture is a picture belonging to the reference layer.

18. A method of decoding scalable video, the method comprising:
determining a position of a reference sample corresponding to an enhancement reference sample within a reference layer, based on a position of the enhancement reference sample belonging to an enhancement layer;
determining at least one reference layer block in the reference layer based on the position of the reference sample;
generating a prediction block corresponding to a current block by performing a prediction of the current block belonging to the enhancement layer based on motion information of the at least one reference layer block; and
generating a reconstruction block corresponding to the current block based on the prediction block,
wherein the position of the enhancement reference sample is determined as a relative position to the current block, and
the position of the reference sample corresponding to the enhancement reference sample is determined based on an input picture size ratio between an input picture of the enhancement layer and an input picture of the reference layer.
